(19) United States
(12) Patent Application Publication
(10) Pub. No.: US 2008/0118301 A1
(43) Pub. Date: May 22, 2008

(54) BALL JOINT ELEMENT AND METHOD OF FORMING SAME

(76) Inventors: Mayuki Nishio, Hamamatsu-shi (JP); Shinichi Nishio, Hamamatsu-shi (JP); Masayuki Nishio, Hamamatsu-shi (JP); Tatsuya Nishio, Hamamatsu-shi (JP)

Correspondence Address: Ernest A. Beutler, Attorney at Law, 10 Rue Marseille, Newport Beach, CA, 92660, US

(21) Appl. No.: 11/872,187

(22) Filed: Oct. 15, 2007

(30) Foreign Application Priority Data
Oct. 18, 2006 (JP) 2006-283509

(51) Int. Cl. F16C 11/00

(52) U.S. Cl. 403/122

(57) ABSTRACT

An improved, light weight ball member for universal connections having a hollow interior both in its ball portion and connecting portion for providing high strength and light weight and method for forming it through an improved forging process, using improved forging dies.

### BACKGROUND OF THE INVENTION

This invention relates to an improved ball joint and method of forming one.

Ball joints are used in a large number of applications for providing pivotal connections that transmit motion for one connected member to another, particularly when the relationship of the connected elements changes during the motion transmission. A typical application in which this invention may be utilized is shown in FIG. 1, that illustrates in perspective a steering arrangement for a wheel of a dirigible front wheel suspension for a vehicle, such as an automobile. Only the steering system of the vehicle is shown, as it is believed that those skilled in the art how the ball joint constructed and manufactured in accordance with the invention may be used in such combinations. Those skilled in the art will also understand that ball joint elements constructed and manufactured in accordance with the invention are capable of use in other combinations using joints of this general type.

The vehicle steering system, indicated generally at 11, includes a steering wheel 12 is positioned in a known manner in the driver's compartment of the vehicle. Greater detail of the vehicle is not shown as noted above to permit easier understanding of a typical application of the invention. The steering wheel 12 is connected to the upper end of a steering shaft 13 that extends at least in part outside of the driver's compartment typically into the vehicle engine compartment.

There it is connected to a steering box 14 for effecting control rotation of a steering pitman arm 15. The outer end of the pitman arm 15 carries, in a manner to be described later, to a ball joint element, indicated generally by the reference numeral 16 constructed and configured in accordance with the invention, as will be described later, by reference to the remaining figures.

The ball joint 16 forms a universal pivotal connection to a linkage system including links 17, 18 and 19 with like ball joints 16 providing the pivotal connections between the directly connected ends of the links. The final pivotal connection is to the supporting element 21 that journals a wheel 22 for both rotation about the wheel axis and for suspension and steering movement, as is well known in the art.

From the foregoing description it should be readily apparent that a ball joint must be capable of providing smooth transmission of movement between connected members with a minimum of friction. Also in many applications such as in vehicle steering linkages it should be robust and also light in weight. The latter desired condition is because it forms a portion of what is referred to as unsprung weight. Also a low cost of fabrication from a strong material is desired.

FIG. 2 illustrates a prior art attempt at achieving these goals. This type of ball joint is used in a large number in the steering system of vehicles and is typified in Japanese Published Application JP-A-2005-31605. The essential part of this prior art type ball joint is comprised generally of a ball joint member 101 rotatably contained in a casing 102. The ball joint member 101 comprised of a smooth ball portion 101a having a spherical sliding surface 101b suitably journalled in the casing 102 and a connecting shaft 101 c extending in radial direction from part of the smooth ball portion 101a.

Recently it has been recognized that in such ball joints, there is desired a reduction in excess material to save resources and reduce weight. A typical method known for this purpose is to provide a weight reducing hole 101d in the smooth ball portion 101a of the ball joint member 101. The hole is bored along the axis from the opposite side of the connecting shaft 101c by forging or machining.

However, if the diameter of weight reducing hole 101d in the ball joint member 101 is enlarged to provide the weight reduction, the sliding surface area of the smooth ball portion decreases, resulting in restricted pivoting angle of the connecting shaft possible. Therefore, there is a restriction to the increase in the size of the weight reducing hole 101d. Alternatively, while it is possible to enlarge the weight reducing hole 101d by machining the inside surface 101b with a cutting tool bit inserted through the opening of the weight reducing hole 101d, the number of machining steps increases and the time of forming increases, which is a factor of increasing manufacturing cost. Therefore, this method is hard to practice.

It is, therefore, a principal object of this invention to provide a light weight, strong ball joint having a large spherical surface and a low cost method of forming it.

### SUMMARY OF THE INVENTION

A first feature of the invention is adapted to be embodied in a ball member for a ball and joint pivotal connection being formed from a single piece comprised of a ball portion adapted to be pivotally connected within a socket formed by one of the elements to be connected and a shank portion adapted to be fixedly secured in a complimentary opening of the other element to be pivotally connected. The ball member has an inner cavity complimentary in shape to said ball and shank portions and closed at both ends.

Another feature of the invention is adapted to be embodied in a method of forming a ball member for a ball and joint pivotal connection formed from a single piece comprised of a ball portion adapted to be pivotally connected within a socket formed by one of the elements to be connected and an integral shank portion adapted to be fixedly secured in a complimentary opening of the other element to be pivotally connected. The method comprises the steps of forging a solid cylindrical piece of metal into the integral ball and shank portions with complimentary closed ball shaped and cylindrical shaped cavities by forging steps.

### BRIEF DESCRIPTION OF THE DRAWINGS

FIG. 1 is a perspective view showing a typical embodiment in which the invention may be employed.

FIG. 2 is a cross sectional view showing a prior art type of ball joint element.

FIG. 3 is a perspective view of a ball joint embodying the invention looking from the shank end and made in accordance with an embodiment of the invention.

FIG. 4 is a perspective view of a ball joint looking from the ball end and made in accordance with an embodiment of the invention.

FIG. 5 is cross sectional views taken through a forged material before forming into the final product FIG. 6 is a cross sectional view of the final product incorporating the invention.

FIG. 7 is a series of cross sectional views showing in the upper portion thereof the shape of the ball joint element during the various forging steps and in the lower portion thereof the forging dies that perform the forging steps.

### DETAILED DESCRIPTION OF THE INVENTION

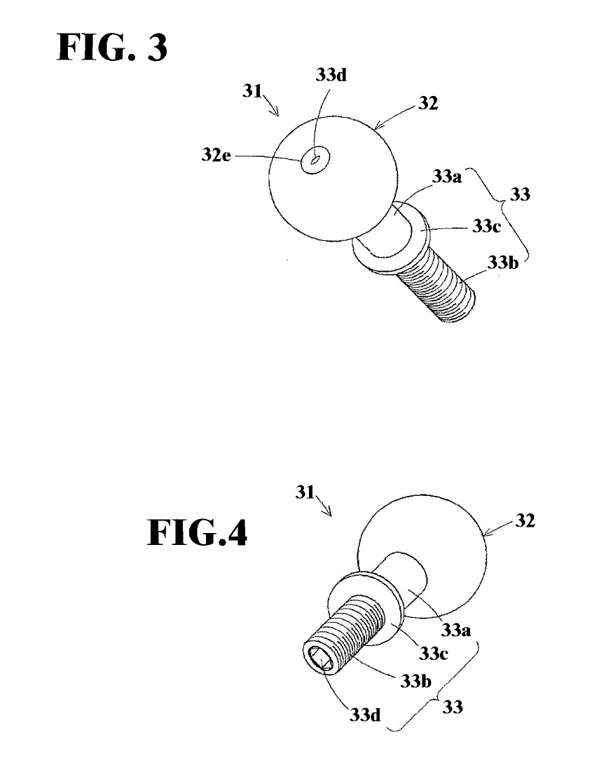

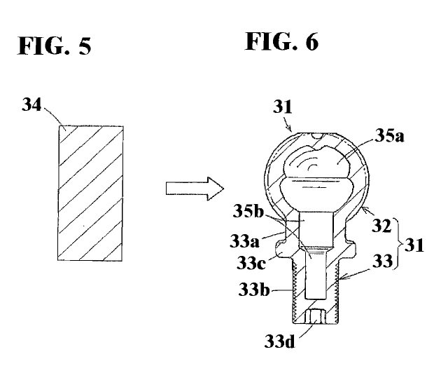

Referring now in detail to the drawings and initially to FIGS. 3 and 4, these are perspective views of a ball joint element configured and manufactured in accordance with the invention. The novel ball joint member is indicated generally by the reference numeral 31, made in a manner to be described shortly by reference to FIGS. 5-7, and is comprised of a smooth ball portion 32 having a spherical journaling surface and a connecting shaft portion 33 provided to project radially from the outer surface of the smooth ball portion 32. The smooth ball portion 32 and the connecting shaft portion 33 are made by applying machining processes such as cutting, rolling and other plastic forming processes to a forged product in a manner that will be described later, as noted above.

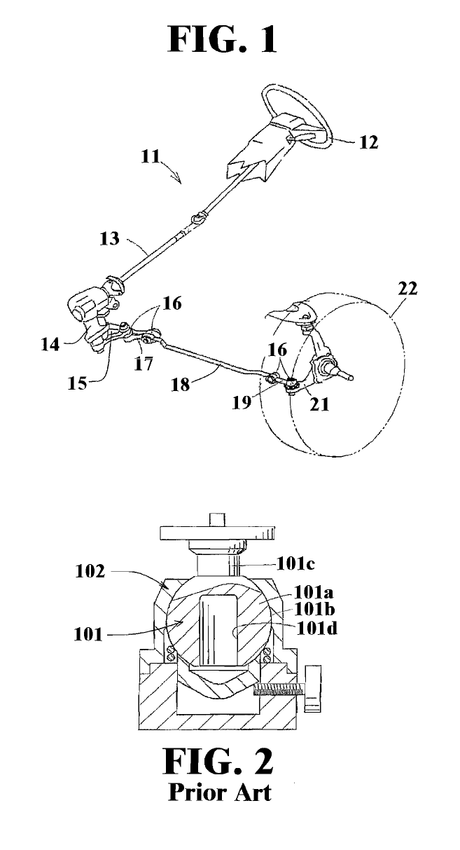

The connecting shaft portion 33 as shown in FIGS. 3 and 4 has an attachment portion 33a receiving a dust cover (not shown), and a male thread portion 33b for connection to an associated link such as the links 17, 18, 19 and 21 (FIG. 1). The reference numeral 33c denotes a flange serving as a partition between the attachment portion 33a and the male thread portion 33b. A reference numeral 33d denotes an Allen wrench receiving hole formed in the axial center of the shaft end. A circular flat surface 32e is provided on the smooth ball portion 32, on the opposite side of the connecting shaft portion 33 for improving efficiency of plastic forming and a forming dent 32f for positioning the operation in the die remain.

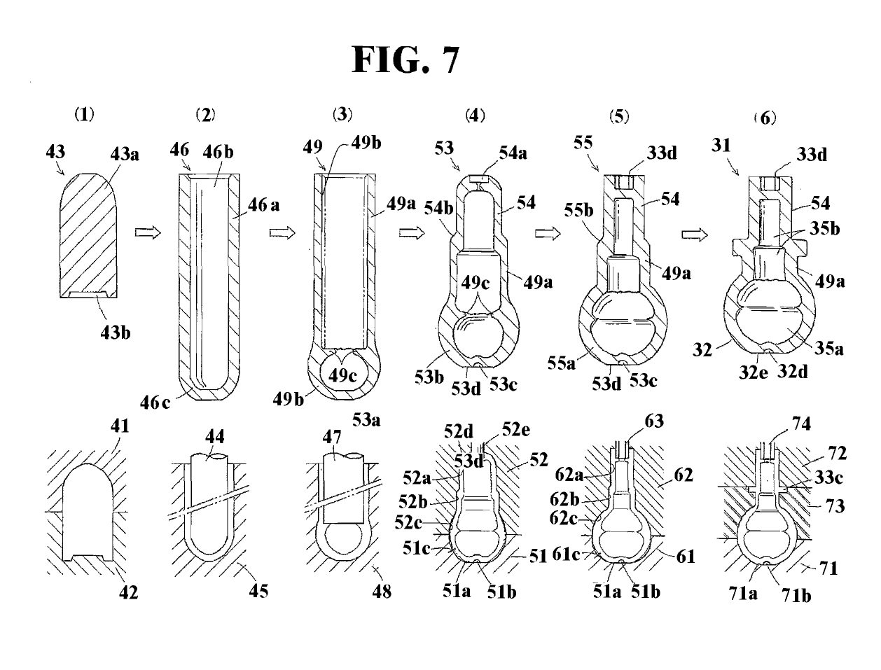

FIG. 5 is a cross sectional view of a circular blank 34 of material that will be formed, from the forging steps shown in FIG. 7 to the finally finished ball joint 31 shown in cross section in FIG. 6.

Referring now to FIG. 6 in detail, the reference numeral 35 denotes generally a weight reduction space formed on the inside surface of the forged product 31. The weight reduction space 35 is formed as a single space by interconnecting a spherical space 35a centered on approximately the same center as that of the external surface so as to have approximately constant wall thickness with an elongated cylindrical space 35b formed coaxially with the connecting shaft portion 33. Incidentally, an annular excess material rib portion 31b present inside the spherical space 35a occurs in the manufacturing process as will be described later in detail.

As described above, the weight is reduced from the ball joint member 16 in the region between the smooth ball portion 32 and the connecting shaft portion 33 approximately along the external surface shape to form the space 35. As a result, excess weight is reduced to a practical minimum. According to this example, a conventional product without weight reduction weighing 65 grams is lightened to 45. In addition, as the weight reduction is made without causing recesses on the outer surface, the same external shape as that of the conventional product results so the function and action the conventional product provides are not impaired.

The actual forming process (forging) will now be described in detail by primary reference to the several views of FIG. 7, that also shows the forging tools employed in each step at the lower portion of this figure and the blank formed by these tools at the upper portions of the figure. The steps are numbered in sequence, but it should be noted that those skilled in the art may employ different steps and/or sequences without departing from the invention.

The forging machine mainly uses in the first steps so-called two-piece split dies disposed to be movable in a generally axial direction toward and away from each other on both sides of the pellet-shaped forging blank 34. The final two steps employ a three-piece split die. The two-piece split die, as is well-known, has die surfaces carved in opposing faces of the split die pieces that move to and away from each other relative to the longitudinal axis of the blank 34. The three-piece split die has a third die interposed between the two split die pieces. In this example, the third die of the three-piece split die is made up of several die pieces that may be separated in radial directions.

Referring now in detail to the steps shown in FIG. 7, a forging blank 34 is formed in the first step shown in FIG. 7(1) by a pair of dies, a pressing die 41 and a receiving die 42, movable to and away from each other, into a first partially processed piece 43 of a roughly bullet shape as a whole with its one end having a convex portion 43a of a semispherical outer shape. The other end is formed with a shallow circular recess portion 43b. This initial shaping is done to smoothen material flow within the dies 41 and 42 to reduce stresses and facilitate the forming in the next step.

In the following second step, the partially processed work 43 is worked by a forming die 44 and a receiving die 45. The partially formed piece 43 is inverted as shown in FIG. 7(2) and is supported in the receiving die 45 that has a semispherical inside bottom. Then, the recess 46b and surrounding wall 46a of the work piece is extended by pressing by the punch-shaped pushing die 44. This produces a second partially processed work 46 of an elongated cylindrical container-like shape having a cylindrical wall portion 46a around an axial hole 46b with its upper end open and an approximately semispherical bottom portion 46c continuous with the cylindrical wall portion 46a. As a practical matter, this step of forming the container-like member is not greatly different from that in conventional forming method.

The third step, shown in FIG. 7(3) constitutes one of the features of the invention. As shown in this figure, a pressing die 47 and receiving die 48 are employed. The bottom portion 46c of the second partially processed work 46 is supported in the receiving die 48 having a die surface of semispherical shape slightly greater in diameter than the bottom portion 46c. The punch-shaped pressing die 47 is slightly greater in diameter than the axial hole 46b and is pressed to draw the inside round surface of the cylindrical wall portion 46a to form a cylindrical wall portion 49a of a further reduced wall thickness, while increasing the inside diameter 49b.

In the process of the pressing die 47 being pressed into the previously formed work piece 46, it is pressed hard against the die surface of the receiving die 48, the bottom portion 49b bulges outward. At the same time, part of the material of the cylindrical wall portion 46a flows into the bulged portion and expands into the die 48, so that an approximately spherical bottom portion 49b is formed.

Also in the process of the pressing by the pressing die 47, excess material is forced out the inside surface of the cylindrical wall portion 46a with the fore-end face of the drawing die 47 is left behind when the pressing die 47 is retracted to form the above-mentioned annular excess material portion 49c rising inward from the vicinity of the bottom portion 44b. In this way, the third step half-processed work 49 is formed with the approximately spherical bottom portion 49b continuous to one end of the thin cylindrical wall portion 49a.

Next, in the fourth step shown in FIG. 7(4), the partially processed work piece 49 resulting from the third step is processed with a receiving die 51 having a semispherical receiving surface, as will be described in more detail shortly, and with a pressing die 52 moving toward and away from the receiving die 51.

The die surface of the pressing die 52, as shown in the lower half of the drawing, has three step portions 52a, 52b, 52c of increasing inside diameters, and a ceiling portion 52d. The ceiling portion 52d carries an axially extending projecting member 52e formed with a round or hexagonal rod shape, which is decided, as will be described later.

The semispherical receiving surface, previously mentioned, of the bottom central portion of the receiving die 51 includes a generally flat portion 51a of a small diameter with a small semispherical projection 51b rising in the center of the flat portion 51a. Further, a space remains between the inside surface of the die and the surface of the half-processed work and to receive the material escaping during the tight-closed forging step. This material receiving area is indicated by the reference numeral 51c.

Thus, as the pressing die 52 moves toward the receiving die 51, the outer surface of a thin cylindrical wall portion 49a is drawn upwardly to form a portion of a further smaller diameter 54. At the same time, the upper end portion of the cylindrical wall portion 31 is depressed by the semispherical ceiling portion 52d of the pressing die 52, and flows along the wall surface while curving radially inward. Thus the wall thickness increases greatly while the outside diameter shrinks. Part of the material flowing at this time goes under the projecting member 52e and its fore-end portions meet together around the center of the shaft to almost close the opening. Thus a preliminary hole 54a for later machining of the engagement hole 19d is formed.

Further, the pressing force applied with the pressing die 52 during the drawing step forms a step portion 54b between the thin cylindrical wall portion 49a and the shaft-shaped small diameter portion 54. Part of the small diameter portion 49a located below the step portion 54b is pushed out to the bottom portion 49b expanded in the previous step, so that its outside round portion expands further to form an enlarged bottom portion 53b.

At this time, a small projection 51b provided on a flat bottom 51a of the receiving die 51 pierces into and axially supports the fourth step half-processed work 53. These produce at the base of the lower portion a dent 53c remaining in the center of a flat surface 53d after the forming step. Further, the reference numeral 51c denotes a space remaining between the inside surface of the die and the surface of the half-processed work for receiving the material escaping during tight-closed forging step.

In this way, on condition that the semispherical die surface of the receiving die 51 is made with some margin in diameter relative to the planned size of the bottom portion 37, the fourth half-processed work 53 having a further expanded spherical portion 53a is formed simply by using dies that restrict the outer shape while vertically compressing the third step half-processed work 49 supported at the upper and lower axial portions.

Next, in the fifth step shown in FIG. 7(5), the fourth half-processed work 53 obtained in the previous step is further compressed in the axial direction so that axial length is shortened while the outside diameter of the spherical portion 53a expands further to approximate the shape of the final forged product 31.

Here are used, like the dies used in the fourth step [FIG. 7 (4)], a receiving die 61 having a semispherical bottom portion for supporting the spherical portion 53a of the fourth half-processed work 53 and a pressing die 62 for correcting the shape of the upper portion.

The pressing die 62, like the pressing die 52, is provided with step portions 62a, 62b, 62c, and a rod-like projection 63 for forming the engagement hole 19d. The receiving die 61 is provided with a small diameter flat surface portion 61a and a semispherical small projection 61b on the bottom portion of the die surface.

Therefore, as the receiving die 61 and the pressing die 62 approach each other, the rod-like projection 63 engages with the preliminary hole 54a of the fourth half-processed work 53 to form the new fifth processed part 55, and the semispherical small projection 61b engages with the forming dent 51b and they are supported respectively.

The die surfaces formed on the inside surface of the pressing die 62 and the projection 63 are configured to form the final shape of the end 33b and the tool receiving hole 33d. Thus when the pressing step of FIG. 7(5) is completed the upper portion of the spherical portion 55a, part of the material around the rod-like projection 63 and the step portion 55b is depressed hard and the material around the tool receiving hole 33d is finished into required shape. At the same time, some of the thin cylindrical wall portion 55c is forced into the upper part of the spherical portion 55a.

At this time, the underside part thicker than the excess material part 55c formed inside the spherical portion 53a expands in diameter and works to pull in the thin cylindrical wall portion 55a that comes flowing to the excess material part 55c. In this way, the fifth half-processed work 55 having the spherical portion 53a of a further increased diameter is obtained.

FIG. 7(6) shows the final, sixth step. This step employs two dies each of which is split along the axial direction (a receiving die 71, and a pressing die 72). Interposed between these two dies (71 and 72) is a third, a split die 73 interposed between the two. The split die 73 is made up of three pieces split in the circumferential direction and movable in radial directions relative to the axis of the work piece 55 to form the finally shaped piece 33. The reference numeral 74 identifies a rod like projection similar to the rod-like projection 63 used in the previous step. This projection 74 is secured to the pressing die 72.

Initially, the forming dent 51b of the fifth half-processed work piece 55 is engaged with the small projection 71b of the receiving die 71. Then the dies 71, 72, and 73 are advanced relative to each other.

This includes engaging the small diameter portion 54 of the workpiece 55 with the step portion of the pressing die 72. Then the pressing die 72 is advanced toward the die 73 while tightening the squeezing die 73 in a radial direction relative to the small diameter portion 54. Thus material flows from the cylindrical wall portion 49a and small diameter portion 54 into a recess 73a provided in the squeezing die 73. As the material fills the recess 73a, the material projects to form the annular flange 33c, so that the forged product 32 is finished. The threaded portion 33b is then machined in a suitable manner.

It should be readily apparent from the foregoing description that the described methodology and apparatus provides a strong low cost ball joint element. However those skilled in the art will readily understand that the methodology and apparatus employed therefore may be subject to various changes and modifications without departing from the spirit and scope of the invention, as defined by the appended claims.

1. A ball member for a ball and joint pivotal connection, said ball member being formed from a single piece comprised of a ball portion adapted to be pivotally connected within a complimentary socket formed by one of the elements to be connected and a shank portion adapted to be fixedly secured in a complimentary opening of the other element to be pivotally connected, said ball portion and said shank portion having an inner cavity complimentary in shape to said ball and shank portions and closed at both ends.

2. A ball member as set forth in claim 1, wherein the ball and shank portion cavities are in open communication with each other.

3. A ball member as set forth in claim 1, wherein the shank portion is formed with an enlarged diameter circular projection intermediate its ends.

4. A ball member as set forth in claim 1, wherein the ball portion is formed with a small recess lying on the axis of the shank portion.

5. A ball member as set forth in claim 4, wherein the shank portion is formed with an enlarged diameter circular projection intermediate its ends.

6. A ball member as set forth in claim 5, wherein the ball portion is formed with a small recess lying on the axis of the shank portion.

7. A method of forming a ball member for a ball and joint pivotal connection being formed from a single piece comprised of a ball portion adapted to be pivotally connected within a socket formed by one of the elements to be connected and a shank portion adapted to be fixedly secured in a complimentary opening of the other element to be pivotally connected, comprising the steps of forging a solid cylindrical piece of metal into the integral ball and shank portions with complimentary closed ball shaped and cylindrical shaped cavities by forging steps.

8. The method as set forth in claim 7, wherein the forging steps comprise an initial step of forging a cylindrical cavity opening through one end of the cylindrical piece of metal and subsequently closing its open end through another forging step.

9. The method as set forth in claim 7, wherein the forging steps include steps of forming the ball portion on successive forging steps where the external diameter is progressively increased.

10. The method as set forth in claim 7, wherein the forging steps include steps of progressively decreasing the diameter of an end of the cylindrical portion.

11. The method as set forth in claim 10, wherein the forging steps comprise an initial step of forging a cylindrical cavity opening through one end of the cylindrical piece of metal and subsequently closing its open end through another forging step.

12. The method as set forth in claim 11, wherein the forging steps include steps of forming the ball portion on successive forging steps where the external diameter is progressively increased

13. The method as set forth in claim 12, wherein the forging steps progressively increase the diameter of the cavity in the ball portion.

14. The method as set forth in claim 13, wherein the forging steps further form a cylindrical enlargement between the ends of the cylindrical portion.
